(19) United States
(12) Patent Application Publication
(10) Pub. No.: US 2011/0294646 A1
(43) Pub. Date: Dec. 1, 2011

(54) APPARATUS AND METHOD FOR MANUFACTURING FLOAT GLASS

(76) Inventors: Woo-Hyun KIM, Dongducheon-si (KR); Sang-Oeb Na, Seoul (KR); Won-Jae Moon, Seoul (KR); Jeong-Deok Kim, Seoul (KR); Kil-Ho Kim, Suwon-si (KR); Heui-Joon Park, Paju-si (KR); Jin Han, Goyang-si (KR); Dong-Shin Shin, Bupyeong-gu (KR)

(21) Appl. No.: 13/149,138

(22) Filed: May 31, 2011

(30) Foreign Application Priority Data
Jun. 1, 2010 (KR) 10-2010-0051988

(51) Int. Cl. C03B 18/18; C03C 3/00; C03B 18/02

(52) U.S. Cl. 501/11; 65/162; 65/158; 65/29.19

(57) ABSTRACT

An apparatus for manufacturing a float glass includes a bottom block in which molten metal is stored to float, a loop block which covers the bottom block, and a plurality of thermocouples buried in the loop block in a predetermined pattern to measure the temperature of the loop block so that a temperature gradient of an inner circumstance of a float chamber formed by the bottom block and the loop block is measured and/or controlled.

### CROSS-REFERENCE TO RELATED APPLICATION

This application claims priority under 35 U.S.C. §119(a) to Korean Patent Application No. 10-2010-0051988 filed at the Korean Intellectual Property Office on Jun. 1, 2010, the entire contents of which are incorporated herein by reference.

### BACKGROUND

1. Field

Exemplary embodiments relate to an apparatus and method for manufacturing a float glass, and more particularly, to an apparatus and method for manufacturing a float glass, which has an improved structure so that the operating conditions of a float chamber such as the temperature gradient in the float chamber may be checked more precisely according to the state of a glass ribbon in the float chamber in order to consistently maintain the quality of a produced glass ribbon.

2. Description of the Related Art

Generally, flat glasses used in the industries such as window panes (e.g., soda lime silica glasses) of vehicles or buildings are mostly produced using a floating process well known in the art. In addition, thin glass panes or glass films (e.g., non-alkali glasses) for TFT displays or the like are also a kind of “float glass” produced using a floating process.

In a conventional float glass manufacturing apparatus, in order to check the forming conditions in a float bath, the temperature of molten metal is measured using a thermocouple or the temperature of a glass ribbon is measured using a pyrometer.

However, when a thermocouple is immersed in molten metal to directly check the temperature of the molten metal or a pyrometer is used for directly checking the temperature of a glass ribbon, there are many conditions, such as a limitation on measurement location. Therefore, it is impossible to detect the change of the operating conditions of a float chamber and to consistently maintain the quality of formed molten glass, such as the overall change in thickness of the molten glass.

### SUMMARY

The exemplary embodiments are designed to solve the problems of the prior art, and therefore the exemplary embodiments are directed to providing an apparatus and method for manufacturing a float glass with an improved structure which may allow the temperature gradient in a float chamber to be indirectly checked by utilizing a loop block whose installation location is not as restricted, so that the temperature in the float chamber may be measured and managed more accurately.

In one aspect, the exemplary embodiment provides an apparatus for manufacturing a float glass, which includes: a bottom block in which molten metal is stored to float; a loop block which covers the bottom block; and a plurality of thermocouples buried in the loop block in a predetermined pattern to measure the temperature of the loop block so that a temperature gradient of an inner circumstance of a float chamber formed by the bottom block and the loop block is measured and/or controlled.

Preferably, the thermocouples are arranged at regular intervals in a width and/or length direction of the loop block.

In another aspect, the exemplary embodiment provides a method for manufacturing a float glass, which includes: continuously supplying molten glass onto the molten metal from an inlet of the apparatus for manufacturing a float glass; forming the molten glass into a glass ribbon on the molten metal; and continuously drawing the glass ribbon from an outlet of the apparatus.

The apparatus and method for manufacturing a float glass according to exemplary embodiments give the following effects.

First, a plurality of thermocouples are arranged in a predetermined pattern in a length and/or width direction of a loop block composed of refractory bricks so that the operating conditions of a float chamber according to the state of a glass ribbon may be checked more accurately irrespective of the installation places.

Second, since the inner circumstance of the float chamber and a heater installed to a float bath may be precisely controlled, operating conditions may be precisely controlled so that they may be applied as working conditions.

### BRIEF DESCRIPTION OF THE DRAWINGS

Other objects and aspects of the present invention will become apparent from the following descriptions of the embodiments with reference to the accompanying drawings in which:

FIG. 1 is an exploded perspective view schematically showing an apparatus for manufacturing a float glass according to an exemplary embodiment;

FIG. 2 is a cross-sectional view showing the apparatus of FIG. 1; and

FIG. 3 is a plan view of a loop block showing a pattern of thermocouples of FIGS. 1 and 2 distributed to a loop block.

### DESCRIPTION OF THE PREFERRED EMBODIMENT

Hereinafter, an apparatus and method for manufacturing a float glass according to exemplary embodiments will be described in detail with reference to the accompanying drawings.

Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

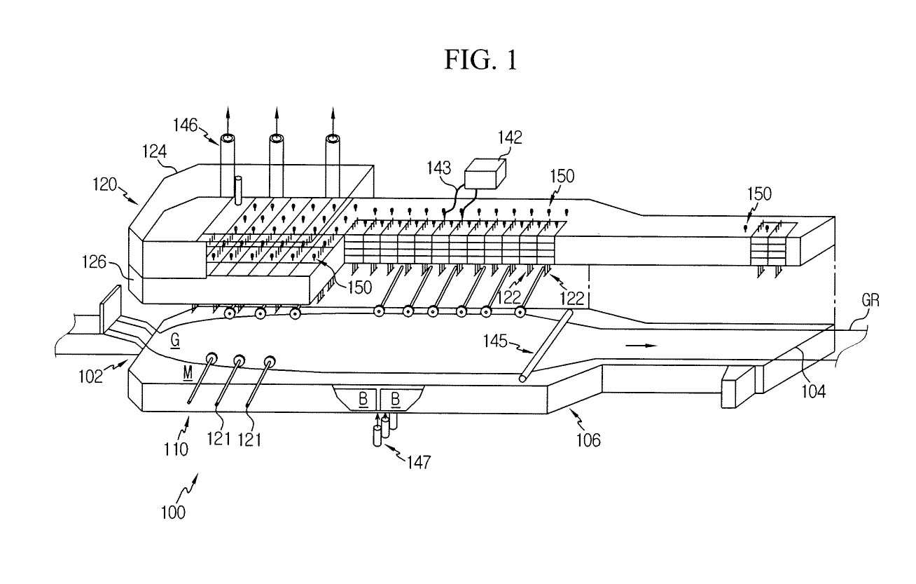

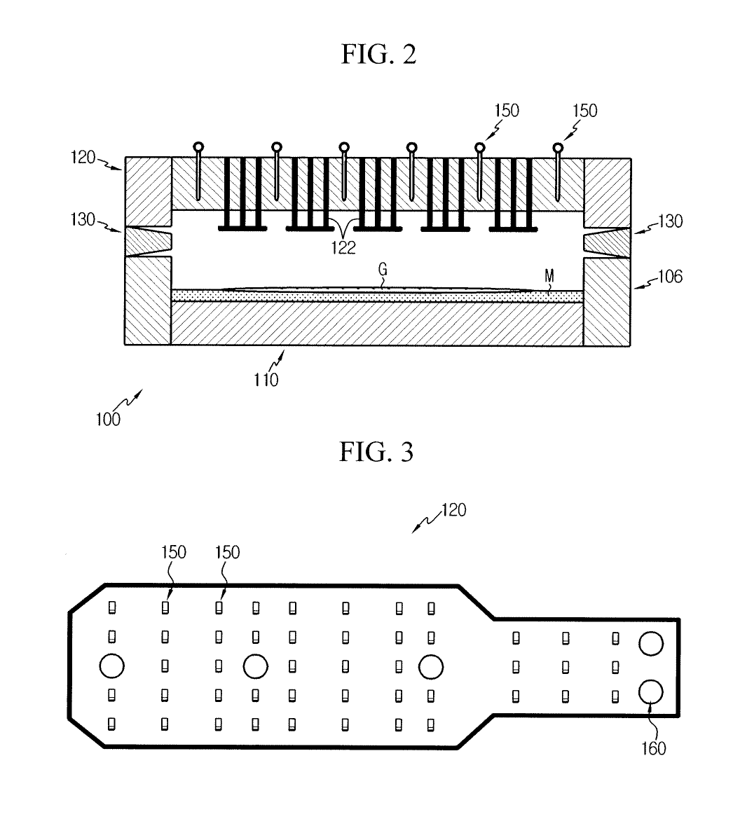

FIG. 1 is an exploded perspective view schematically showing an apparatus for manufacturing a float glass according to an exemplary embodiment, FIG. 2 is a cross-sectional view showing the apparatus of FIG. 1, and FIG. 3 is a plan view of a loop block showing a pattern of thermocouples of FIGS. 1 and 2 distributed to a loop block.

Referring to FIGS. 1 to 3, the apparatus 100 for manufacturing a float glass (or, a float bath) according to this embodiment includes a bottom block 110 in which molten metal M is filled and floats, a loop block 120 positioned above the bottom block 110 to cover the bottom block 110, and a side seal 130 interposed between the loop block 120 and the bottom block 110.

The bottom block 110, the loop block 120 and the side seal 130 configure a sealed float chamber 106 with an inlet 102 and an outlet 104 as a whole. The inside of the float chamber 106 is filled with a mixed gas of nitrogen and hydrogen. The mixed gas is kept at a pressure slightly higher than the atmospheric pressure. The molten metal M and ribbon-shaped molten glass G are kept at about 600 to 1,300° C. by a heater 122 installed in a brick layer of the loop block 120. The molten glass G is a non-alkali glass, a soda lime glass or the like. The principle or structure of generating a flow of the molten metal M in the float chamber 106 and the process of putting, forming into a ribbon shape, moving or discharging the molten glass G are already well known in the art as a floating process, and they are not described in detail here. Reference numeral 141 represents a top-roller for forming the molten glass G. Reference numeral 142 represents a transformer for supplying and/or controlling power to the heater 122. Reference numeral 143 represents a bus bar which electrically connects the transformer 142 to the heater 122. Reference numeral 145 represents a tin barrier for controlling a floating direction of the molten metal M. Reference numeral 146 represents a venting system for discharging the gas in the float chamber 106 to the outside. Reference numeral 147 represents a cooling member for cooling the bottom block 110.

The bottom block 110 is composed of plural bricks B arranged in a length direction of the float chamber 106 so that molten metal M such as a molten tin, a molten tin alloy or the like may be stored thereon. The bricks B are surrounded by a metal casing (not shown).

The side seals 130 are located at the upper surface of the bottom block 110 and the lower surface of the loop block 120 to seal the float chamber 106 by substantially isolating the inside of the float chamber 106 from the outside. The side seals 130 are a plurality of structures with a substantially hexahedral shape, which are adjacently arranged in a length direction of the float chamber 106. The side seals 130 may have discharge holes at several locations so that the discharge holes communicate with the venting system 146.

The loop block 120 includes a steel loop casing 124 which hangs from an upper structure (not shown) such as a crossbeam in a building to which the float chamber 106 is installed, and a side block 126 which is made of lining heat-retaining bricks and disposed in a lower space of the loop casing 124. The inner space of the loop block 120 is divided into an upper space and a lower space by a loop brick layer.

The float chamber 106 according to the exemplary embodiment includes a plurality of thermocouples 150 arranged at the loop block 120 of the float chamber 106 in a predetermined pattern in length and width directions of the loop block 120. The thermocouples 150 allow the temperature gradient of an inner circumstance of the float chamber 106 to be checked indirectly. In other words, the temperature of the inner circumstance of the float chamber 106 may be precisely measured and managed by using the temperature of the loop block 120, which is measured by the thermocouples 150.

Each thermocouple 150 is installed in the loop block 120 so that one end thereof extends from the upper space of the loop block 120 through the loop block 120 nearly to the lower end of the loop block 120.

Referring to FIG. 3, five thermocouples 150 are arranged substantially in parallel with each other in a width direction of the loop block 120. The thermocouples 150 disposed adjacently in a length direction of the float bath 100 may be arranged more densely in the length direction of the float chamber 106 in a region where the temperature of the inner circumstance should be measured more precisely, while the thermocouples 150 may be arranged less densely in the length direction of the flat chamber 106 in a downstream region where the temperature of the inner circumstance may not be measured precisely.

The thermocouple 150 may be any thermocouple known in the art, which may suitably measure the temperature of the inner circumstance of the float bath. Reference numeral 160 represents holes in which pyrometers are installed.

According to a method for manufacturing a float glass according to an exemplary embodiment, the float bath 100 according to the above embodiments is used to manufacture a glass with a forming temperature of 600 to 1,300° C. by a float process. In other words, molten glass G has a lower viscosity than molten metal M, and the weight of the molten glass G is about ⅔ of that of the molten metal M. The molten glass G is continuously supplied into the float bath 100 through the inlet 102 of the float chamber 106 and then advances to the downstream side of the float chamber 106 while floating and spreading on the molten metal M. In this process, the molten glass G reaches an equivalent thickness according to its surface tension and the gravity so that a glass strip or ribbon GR which is solidified to some extent is formed. The glass ribbon GR is drawn by lift-out rollers (not shown) adjacent to the outlet 104 of the float chamber 106 and is pulled toward an annealing lehr (not shown). In addition, the thickness of the produced glass ribbon GR may be changed according to the amount of molten glass G put through the inlet 102 or the pulling speed determined by a rotating speed of the lift-rollers or when forming means such as the top-rollers 141 installed in the float chamber 106 is controlled or changed. Therefore, the float bath 100 may perform a circulating process endlessly and operate on a permanent basis. In fact, the float bath 100 according to this embodiment may manufacture a float glass without cessation over several years. Here, the drawing speed of the glass ribbon GR would be generally 1 to 200 ton/day. In this process, the temperatures at several locations of the loop block 120 may be measured using the thermocouples 150 installed to the loop block 120 of the float chamber 106 in a predetermined pattern. The temperature of the inner circumstance of the float chamber 106 at the corresponding locations may be indirectly checked by the measured temperatures of the loop block 120. Therefore, it is possible to check the temperature of the molten metal M and/or the temperature gradient of the molten glass G at the corresponding locations. The measured temperatures may be compared with a demanded thickness of the glass ribbon formed, and the measured temperatures may be referred to as data for controlling the temperature of the heater 122 at the corresponding location.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An apparatus for manufacturing a float glass, comprising:
a bottom block in which molten metal is stored to float;
a loop block which covers the bottom block; and
a plurality of thermocouples buried in the loop block in a predetermined pattern to measure temperature of the loop block so that a temperature gradient of an inner circumstance of a float chamber formed by the bottom block and the loop block is measured and/or controlled.

2. The apparatus for manufacturing a float glass according to claim 1, wherein the thermocouples are arranged at regular intervals in a width and/or length direction of the loop block.

3. A method for manufacturing a float glass, comprising:
continuously supplying molten glass onto the molten metal from an inlet of the apparatus for manufacturing a float glass according to claim 1;
forming the molten glass into a glass ribbon on the molten metal; and
continuously drawing the glass ribbon from an outlet of the apparatus.

4. A float glass manufactured by the method according to claim 3.
